(19) United States
(12) Patent Application Publication
(10) Pub. No.: US 2010/0243571 A1
(43) Pub. Date: Sep. 30, 2010

(54) METHOD FOR ADSORPTION OF PHOSPHATE CONTAMINANTS FROM WATER SOLUTIONS AND ITS RECOVERY

(75) Inventors: Raphael Semiat, Haifa (IL); Grigory Zelmanov, Holon (IL)

Correspondence Address: BROWDY AND NEIMARK, P.L.L.C.;624 NINTH STREET, NW, SUITE 300, WASHINGTON, DC, 20001-5303, US

(73) Assignee: Technion Research and Development Foundation Ltd., Haifa (IL)

(21) Appl. No.: 12/742,533

(22) PCT Filed: Nov. 12, 2008
(86) PCT No.: PCT/IL2008/001486

§ 371 Date: May 12, 2010

Related U.S. Application Data
(60) Provisional application No. 60/987,210, filed on Nov. 12, 2007.

(51) Int. Cl. C02F 1/28

(52) U.S. Cl. 210/668; 210/681; 210/670

(57) ABSTRACT

Aqueous fluid polluted with phosphate contaminants is mixed with or passed through an adsorbent material selected from: (i) particles of oxides or hydroxides of transition metals, aluminum oxides or hydroxides, TiO2, or mixtures thereof, or (ii) particles of activated carbon, activated alumina, aluminum oxide, activated TiO2, TiO2, mineral clay, zeolite, or an ion exchanger loaded with nanoparticles of oxides or hydroxides of transition metals, aluminum oxides or hydroxides or TiO2, or mixtures thereof, to yield aqueous fluid purified from phosphate. The adsorbent material is further regenerated by increasing the pH of the adsorbent sludge, concentrated phosphate solution or a phosphate crystal slurry is recovered as well.

### FIELD OF THE INVENTION

The present invention relates to an adsorption method for treating a fluid containing undesired phosphate and optional organic contaminants and to a process of regeneration of the adsorbent and the adsorbate materials. Oxides or hydroxides of transition metals in a form of nano-particles or colloids are used as adsorbents. The method is suitable for the elimination of phosphate contamination from drinking water, surface water, ground water, industrial effluent and for chemical regeneration of the adsorbent such as aluminum oxide, titanium oxide, as well as of the removed phosphate.

### BACKGROUND OF THE INVENTION

Phosphorus is an important element for agricultural and industrial development. Large quantities of phosphates are often present in domestic wastewater, groundwater, and industrial wastewaters. Frequently the phosphate solutions include also undesirable organic compounds. Traditional water treatment processes such as adsorption, coagulation, flocculation and membrane technologies achieve removal of the undesired contaminants by merely transferring the pollutants from one phase to another, producing concentrated sludge and leaving the problem of disposing the transferred pollutants, regeneration of the removed adsorbent and production of concentrated phosphate solution or crystals for secondary exploit.

Water treatment processes based on the chemical oxidation of organic compounds by Advanced Oxidation Processes (AOPs), which are useful for purifying surface water and groundwater and for cleaning industrial wastewater, have been reported recently (Sigman et al., 1997; Yeber et al., 2000; Perez et al., 2002). The degradation and mineralization of organic pollutants in wastewater by AOPs is based on the generation of a very reactive free hydroxyl radical (OH*). This radical is generated by the decomposition of hydrogen peroxide with ferrous iron-Fe²⁺. The hydroxyl radical is highly reactive, non-selective and may be used to degrade a wide range of organic pollutants (Safarzadeh-Amiri et al., 1996, 1997). The resulting organic radicals then react with most organic compounds and leads to the complete mineralization to form CO₂, H₂O and mineral acids (Safarzadeh-Amiri et al., 1996, 1997; Oliveros et al., 1997).

The inhibitory effect of inorganic phosphates ions, such as PO₄⁻³/HPO₄⁻²/H₂PO₄⁻¹ plays a significant role in the reaction rate of the Fenton process (Andreozzi et al., 1999; De Laat et al., 2004; Maciel et al., 2004). The main reason for the suppression effect of phosphate ions is that these ions produce a complex reaction together with ferrous and ferric ions, thus causing loss of catalytic activity (Lu et al., 1997).

As follows from unpublished results of experiments which were performed by the inventors, the treatment of an aqueous solution having an initial phenol concentration of 1100 ppm with 80 ppm Fe³⁺ nanocatalyst and 0.48% hydrogen peroxide, in the absence of phosphorous ions dissolved in water, resulted in a phenol concentration of 0.35 ppm within 5 min. However, when the phosphorous ion concentration exceeded 75 ppm, the other extreme condition here, the phenol concentration remained unchanged throughout the experiment. From these data, it was concluded that Fenton, photo-Fenton and Fenton-like processes are not efficient in the presence of inorganic ions-radical scavengers such as PO₄⁻³/HPO₄⁻²/H₂PO₄⁻¹ ions. This problem can be solved by increasing the concentration of the catalyst or concentrations of hydrogen peroxide. Thus, by increasing Fe³⁺ nanocatalyst concentration to 200 ppm, phenol is efficiently destroyed and its concentration decreased from 1100 to 1.9 ppm in 5 min of reaction. Similarly, an increase of the hydrogen peroxide concentration leads to the initiation of the reaction. Thus, for initial concentration of 1100 ppm phenol, 100 ppm Fe³⁺ nanocatalyst, concentration of phosphorous ions greater than 75 ppm and 0.48% hydrogen peroxide, no phenol oxidation reaction was observed. By raising hydrogen peroxide concentration to 0.96%, phenol is effectively destroyed and its concentration decreased from 1100 ppm to 0.85 ppm. Such increase of Fe⁺³ nanocatalyst and hydrogen peroxide concentration made this treatment still cost ineffective for water purification. Therefore, selective phosphate removal from purged water followed by organic contaminant demineralization is extremely important. Moreover, after the selective phosphate removal, degradation of organic components by AOPs process becomes more cost effective.

Physicochemical treatment methods and biological nutrient removal are the two most commonly used methods for removal of phosphate from municipal and industrial wastewater (Jenkins and Hermanowich, 1991; Stensel, 1991). These processes essentially transfer phosphate from the liquid to the sludge phase, which needs to be hauled and disposed of elsewhere. Also, complete phosphate removal is unattainable by these methods due to thermodynamic and kinetic limitation (Zhao and Sengupta, 1998).

Crystallization of calcium phosphate is a frequently used method of phosphorus removal, mainly because of low cost and ease of handling. Removal is achieved by direct precipitation of calcium phosphate (hydroxyapatite, Ca₅(PO₄)₃(OH) (Yi and Lo, 2003), using calcite or calcium silicate hydrate as seeding material (Donnert and Salecker, 1999a, 1999b). The hydroxylapatite crystallizes at pH 8.0-8.5 without inducing the precipitation of calcium carbonates that usually negatively affect the process. However, calcium phosphate precipitation method is not effective in the removal of phosphate and achieves removal efficiencies ranging from 75% to 85% (Moriyama et al., 2001).

The most widely applied biological wastewater treatments such as activated sludge process are not effective in the removal of phosphate (Ivanov et al., 2005; Burdick et al., 1982) and achieve removal of only 65% of total phosphate with the anaerobic process. Phosphate is an essential nutrient in aquatic environment, but excessive phosphate in surface water may lead to eutrophication (Ma and Zhu, 2006).

A coagulating sedimentation method using a coagulant to remove phosphate as slightly soluble salt is a common physicochemical treatment method and its usage depends on the economy and efficiency of the process.

It is well known to add solutions of salts such as FeCl₃ or Al₂(SO₄)₃ as coagulants into municipal sewage; this causes precipitation of, for instance, FePO₄, which is removed as sludge (U.S. Pat. No. 5,876,606). However, excess iron needs to be removed continuously.

Water treatment based on the adsorption of contaminants from solutions by adsorbent material is useful for purification of drinking water, groundwater and for cleaning of industrial wastewater (Ma and Zhu, 2006).

Adsorbents are chosen from materials with porous structure and large internal surface area such as granular or powder activated carbon, activated alumina, mineral clay, zeolite, ion exchanger, or mixtures thereof (Roostaei and Tezel, 2004).

Sorption is relatively useful and cost effective for the removal of phosphate (Oguz, 2004; Rhoton and Bigham, 2005). Activated carbons are among the most effective adsorbents; however, they are almost ineffective for phosphate removal, and yet they are rather expensive to use (Randall et al., 1971).

Attempts have been made to exploit low-cost, naturally occurring sorbents to remove phosphate contaminants from wastewater. The application of low-cost and easily obtainable materials in wastewater treatment has been widely investigated (Van den Heuvel and Van Noort, 2004; Tanada et al., 2003). Using adsorption processes for water treatment requires recovery of the adsorbent material. Application of an adsorbent depends on its cost and on the adsorption capacity after some adsorption-recovery cycles.

Adsorption techniques for treatment of solutions containing undesired phosphate contaminants are described in patent documents. U.S. Pat. No. 5,876,606 describes a method for treating water contaminated with phosphates comprising treatment with waste material derived from a steel manufacturing process that includes metal oxides, for example, iron oxide or iron hydroxide. U.S. Pat. No. 5,976,401 and EP 0823401 describe a method for treating phosphate-containing waste water comprising treating with a metal hydroxide complex comprising at least one divalent metal ion selected from Mg²⁺, Ni²⁺, Zn²⁺, Fe²⁺, Ca²⁺ and Cu²⁺; and at least one metal ion selected from Al³⁺ and Fe³⁺. U.S. Pat. No. 6,136,199 describes a method for removal of phosphates and chromates from contaminated water by a new class of sorbent, referred to as a Polymeric Ligand Exchanger (PLE), in which the exchanger bed comprises a styrene-divinylbenzene or polymethacrylate matrix having an electrically neutral chelating functional group with nitrogen or oxygen donor atoms, and a Lewis-acid type metal cation, such as copper, bonded to the chelating functional group in a manner that the positive charges of the metal cation are not neutralized.

Regeneration of adsorbent includes usage of a desorbing solution. U.S. Pat. No. 5,976,401 and EP 0823401 describe a main step including calcination of the phosphate-containing adsorbent at about 430-600° C. and treatment of the phosphate adsorbent after calcination with at least one phosphate-desorbing agent selected from alkaline metal salts or alkaline earth metal salts other than alkaline metal carbonates and alkaline earth metal carbonates to regenerate and recycle the phosphate adsorbent.

### SUMMARY OF THE INVENTION

It is an object of the present invention to provide an efficient and cost effective method for cleaning of aqueous fluids containing phosphate contaminants, in the absence or the presence of organic pollutants, especially of domestic water, surface water, groundwater, and industrial wastewater by selective adsorption of the phosphate contaminants from the aqueous solutions.

In one aspect, the present invention relates to a method for treating a polluted aqueous fluid containing undesired phosphate contaminants, comprising selective adsorption of said phosphate contaminants onto particles of an adsorbent material selected from: (i) particles of oxides or hydroxides of transition metals, aluminum oxides or hydroxides, TiO₂, or mixtures thereof, or (ii) particles of activated carbon, activated alumina, activated aluminum oxide, activated TiO₂, TiO₂, mineral clay, zeolite, or an ion exchanger loaded with nano-particles of oxides or hydroxides of transition metals, aluminum oxides or hydroxides, or TiO₂, or mixtures thereof, by mixing or passing the polluted aqueous fluid through said adsorbent material to yield aqueous fluid purified from phosphate.

In one embodiment of the invention, the method further comprises regeneration of the spent adsorbent material containing the adsorbed phosphate contaminants and of the phosphate for further use, which comprises:

(i) separation of the adsorbent material loaded with the undesired phosphate contaminants from the purged water by filtration, thus producing a concentrated sludge;

(ii) regeneration of the adsorbent material free from phosphate contaminants from the produced concentrated sludge by increasing the pH to above 7, whereby the adsorbed phosphate contaminants are desorbed from the adsorbent to form a concentrated phosphate solution or phosphate crystal slurry; and

(iii) separation of the regenerated purified adsorbent from the concentrated phosphate solution or crystal slurry.

The adsorption of the phosphate contaminants onto the adsorbent material is carried out at a pH below 7, for example, at a pH from about 2 to about 7, preferably from 4 to 6.5. In order to recover the adsorbent material, the pH of the spent adsorbent sludge or aqueous diluted spent adsorbent sludge is brought to pH above 7, for example, to basic pH values from about 7.5 to about 13, preferably from about 8 to about 12.5. As a result, an adsorbent substantially free from adsorbed phosphates as well as a concentrated phosphate solution are formed. Both materials are ready for repeated use.

In another embodiment of the invention, the aqueous fluid contains organic and/or biological contaminants that are removed by known techniques such as Advanced Oxidation Processes (AOPs), biological waste water treatment or by a sorption process.

In a further aspect, the invention relates to a method for treating a polluted aqueous fluid containing undesired phosphate contaminants and organic and/or biological contaminants, comprising selective adsorption of said phosphate contaminants onto particles of an adsorbent material and concomitant recovery of the purified adsorbent material and of the purified phosphate for further use, said method comprising:

(i) adsorbing the phosphate contaminants onto particles of oxides or hydroxides of transition metals, aluminum oxides or hydroxides, TiO₂, or mixtures thereof, or particles of activated carbon, activated alumina, aluminum oxide, activated TiO₂, TiO₂, mineral clay, zeolite, or an ion exchanger loaded with nano-particles of oxides or hydroxides of transition metals, aluminum oxides or hydroxides or TiO₂, or mixtures thereof, by mixing or passing the polluted aqueous fluid through said adsorbent material;

(ii) separating the adsorbent material loaded with the undesired phosphate contaminants from the purged water by filtration, thus producing a concentrated sludge;

(iii) regenerating the adsorbent material free from phosphate contaminants from the produced concentrated sludge by increasing the pH to above 7, whereby the adsorbed phosphate contaminants are desorbed from the adsorbent to form a concentrated phosphate solution or phosphate crystal slurry;

(iv) separating the regenerated purified adsorbent free from phosphate contaminants from the phosphate solution or slurry, thus obtaining purified adsorbent material and purified phosphate solution or phosphate crystals slurry for further use; and.

(v) removing remained organic and biological pollutants in the treated aqueous fluid by known techniques including Advanced Oxidation Processes (AOPs), biological wastewater treatment or by a sorption process, thus obtaining purified water free from phosphate, organic and biological pollutants.

### DETAILED DESCRIPTION OF THE INVENTION

The method of the present invention can be defined as an adsorption and regeneration process for treating a fluid containing undesired phosphates contaminants in the absence or in the presence of organic pollutants. The phosphate contaminants are selectively adsorbed onto an adsorbent material from a solution with pH below 7 that can be as low as pH 2. The loaded adsorbent may be separated in a form of sludge from the purged water.

The method of the invention allows and encompasses the regeneration of the adsorbent material and of the phosphate for further use. The adsorbent is regenerated by washing with water solution where the pH is above 7, preferably at pH from about 7.5 to about 13, more preferably, from 8 to 12.5, whereby the adsorbed contaminants are desorbed from the adsorbent to form concentrated phosphate solution or phosphate crystal slurry. Finally, the regenerated adsorbent is separated from the concentrated phosphate solution or slurry, for example, by filtration, and both materials, the adsorbent and the adsorbate, are ready for repeated use.

After the removal of the phosphate, any organic and biological pollutants can be removed from the treated water by known techniques such as Advanced Oxidation Processes (AOPs), biological wastewater treatments, or by the sorption.

In preferred embodiments of the invention, the treated aqueous fluid is water including potable water, tap water, ground water, or industrial, agricultural or municipal wastewater. The aqueous fluid may also be obtained from sludge or other solid waste mixed with or adsorbed by soil contaminated with phosphate, wherein the sludge, soil waste or soil is extracted with acidulated water to produce an aqueous fluid containing the undesired phosphate contaminants.

The adsorbent material may be in the form of particles, nanoparticles or colloids.

In one embodiment, the adsorbent material is selected from particles or nano-particles of at least one iron (2,3) oxide or hydroxide, aluminum oxide or aluminum hydroxide, TiO₂, or mixtures thereof. In preferred embodiments, the adsorbent is selected from Fe₂O₃, FeOOH, FeFe₂O₃, Fe(OH)₃, MnFe₂O₃, CoFe₂O₃, CuFe₂O₃, FeO, Al₂O₃, AlOOH, Al(OH)₃; TiO₂, or mixtures thereof, in the form of nano-particles. In one more preferred embodiment, the adsorbent material is composed of nano-particles of iron (III) oxide that may be prepared in-situ from FeCl₃×6H₂O.

In another embodiment, the adsorbent material is selected from particles of activated carbon, activated alumina, aluminum oxide, activated titanium dioxide, titanium dioxide, mineral clay, zeolite or an ion exchanger loaded with nano-particles of oxides or hydroxides of transition metals, aluminum oxides or hydroxides, TiO₂, or mixtures thereof. The oxides or hydroxides of transition metals, aluminum oxides or hydroxides, TiO₂, or mixtures thereof, are as defined above. In one preferred embodiment, the adsorbent material is composed of particles of activated carbon loaded with nano-particles of iron (III) oxide.

The nanoparticles according to the invention may have a size within the range of about 5 to 400 nanometer, preferably about 50 to about 200, more preferably about 80 to about 150 or about 100 nm.

In the method of the invention, the adsorbent material used may be a virgin or a regenerated adsorbent.

The iron oxide adsorbent will gradually become saturated due to the adsorption of the contaminants onto its surface. It is important economically and environmentally to recycle the spent iron oxide and the phosphate contaminants. The desorption process according to the method of the present invention allows efficient reactivation of the spent iron oxide and the phosphates for further use. As shown in the Examples section hereinafter, the spent iron oxide could be regenerated at least 7 times by the proposed desorption and separation method.

The adsorption of the phosphate contaminants is performed at pH conditions such as from pH of about 2 to about 7, preferably, from pH=5 to pH=6.0. The concentration of PO₄⁻³ was reduced in these experiments from 40 ppm to 0.05-0.1 ppm for adsorption at pH range of 5-6, and to 1.5 ppm for pH value of about 7.

The adsorbent loaded with the phosphate is separated from the purified solution to form sludge by means of separation technique such as filtration, centrifugation, precipitation, etc.

In the desorption step for recovering the adsorbent while producing a concentrated phosphate solution or phosphate crystals for repeated use, a water wash solution at pH above 7 is used for treating the adsorbent loaded with the phosphate. The preferable pH range for desorption is from pH=7.5 to pH=13; the most preferable desorption range is from pH=8 to pH=12.5. This is achieved by addition of solutions containing Na, Ca, K, NH₄ or Mg ions, for example, hydroxides or salts, or mixtures thereof, thus resulting in production of salt crystals containing phosphate. This technique may be used for phosphate removal from water and for its recovery for repeated use.

By employing adsorbent of this invention a removal and recovery of up to of 99% of the total phosphate can be achieved.

The present invention also provides an environmentally compatible process for eliminating phosphate contaminants contained in sludge or other solid wastes, or mixed with or adsorbed by soil. This process comprises the steps of: extracting the sludge, soil waste, or soil with a phosphate using solvent or with water or acid to produce a fluid containing the phosphate materials and their purification by the present method.

A list of non-exhaustive applications for the present invention and economic significance of these applications are presented herein. Contamination of water with phosphates presents a significant ecological problem. Traditional water treatments include some processes such as: adsorption, coagulation, flocculation and membrane technologies achieve the removal of the pollutants by separation. These non-destructive technologies only transfer the pollutants from one phase to another and produce problematic sludge, leaving a problem of disposal of the transferred materials, recovery adsorbent and producing concentrated phosphate solution, or phosphate crystals for repeated use. Today, the primary method of disposing of waste is through landfill. A number of industries produce phosphate contaminants as by-products, disposed by landfill. Landfill and incineration require also considerable transportation costs. The technology described herein offers the ability to treat phosphate-contaminated materials directly and eliminates the need for landfill.

The present invention constitutes a new adsorption-regeneration technology for phosphate removal and allows repeated usage of the adsorbent material and of the recovered phosphate at an economically competitive cost, significantly below the mentioned above state-of-the-art technology as it illustrated by the following examples.

The invention will now be illustrated by the following non-limiting examples.

### EXAMPLES

### Experimental Design and General Protocol

Iron chloride hexahydrate, FeCl₃×6H₂O (analytical grade; Merck KGaA, Germany), potassium dihydrogen phosphate (analytical grade; Sigma-Aldrich Laborchemikalien GmbH, Germany), chemically pure calcium chloride (BioLab Ltd., Israel) and activated carbon (Sigma-Aldrich Laborchemikalien GmbH, Germany) were used as received. Typical organic contaminant: phenol (analytical grade, Fluka) was chosen as a simulation compound for organic pollutants.

The pH was determined using a Consort P-901 electrochemical analyzer.

Iron and phosphate concentrations were determined in a data logging Hach DR/2010 spectrophotometer by using FerroVer and PhosVer 3 methods consequently. The concentration of the organic pollutant (phenol) was measured using the multi N/C 2100S, Analytic Jena AG analyzer as the total organic carbon (TOC).

The starting material used for preparing the iron (III) oxide nanoparticles adsorbent was iron chloride hexahydrate, FeCl₃×6H₂O (analytical grade; Merck). Hydrolysis was used to prepare a 10% sol iron oxide nanoadsorbent. A series of iron oxide nanocatalysts was then prepared by diluting the initial solution.

A series of experiments were conducted to investigate the adsorption-recovery properties of iron oxide nanoparticles and aluminum oxide foam. All these experiments were carried out at room temperature.

### Example 1

### Removal of Phosphate from Water Using Iron Oxide Nanoadsorbent

Iron oxide nanoadsorbent (about 100 nm) was prepared as follows: 100 ml distillate water was mixed with 35 g iron chloride hexahydrate at room temperature during 120 min.

This 10% sol iron oxide nanoadsorbent was used to purify a portion of polluted water: 1000 ml aqueous solution containing 40 ppm PO₄⁻³ and 50 ppm Ca²⁺. The results of purification of polluted water experiments for different iron oxide nanoadsorbent concentrations are presented in Table 1.

TABLE 1
Phosphate removal from water using iron oxide nanoadsorbent

| | Adsorption characteristics | | | | | | | | |
|---|---|---|---|---|---|---|---|---|---|
| | Concentration, ppm | | | | | | PH | | |
| | | | | Residual, | | | | After | Residual, |
| | Initial | | | end of process | | | | adding | end of |
| Exp. Num. | Ca⁺² | PO₄⁻³ | Fe | Ca⁺² | PO₄⁻³ | Fe | Initial | adsorbent | Process |
| 1-1 | 52 | 42 | 60.75 | 52 | 0 | 0.2 | 2.51 | 1.97 | 4 |
| 1-2 | 52 | 41 | 37.75 | 52 | 0.05 | 0.25 | 2.49 | 2.17 | 4 |
| 1-3 | 48 | 42 | 30 | 48 | 2.21 | 0.2 | 2.48 | 2.33 | 4 |
| 1-4 | 48 | 42 | 24.5 | 48 | 5.9 | 0.2 | 2.48 | 2.44 | 4 |
| 1-5 | 48 | 41.25 | 19.75 | 48 | 11 | 0.25 | 2.51 | 2.43 | 4 |
| 1-6 | 51 | 42 | 16.5 | 51 | 16.5 | 0.2 | 2.51 | 2.42 | 4.1 |
| 1-7 | 49 | 40.75 | 10.4 | 49 | 23.9 | 0.15 | 2.5 | 2.44 | 4.1 |
| 1-8 | 51 | 43 | 5.65 | 51 | 33.6 | 0.15 | 2.51 | 2.49 | 4 |

In these experiments, initial acidity (pH=2.5) of contaminated water was chosen to avoid precipitation of calcium phosphate. After addition of the iron oxide nanoadsorbent, the pH of water was adjusted to 4.0-4.1 by adding solution of NaOH. The adsorbent loaded with phosphate contaminants was removed from the water as a concentrated sludge by means of filtration using 0.45 μm filter paper (filter paper of pore size 0.45 μm).

In these experiments the concentration of PO₄⁻³ in contaminated water was reduced from 40 ppm to 0-0.05 ppm for nanoadsorbent concentrations 37-60 ppm of Fe. The mass of adsorbed PO₄⁻³ per unit mass of nanoadsorbent was 700-1600 mg/g. Thus, the iron oxide nanoadsorbent demonstrated extremely high adsorption capacity.

### Example 2

### Removal of Phosphate from Water Using Iron Oxide Nanoadsorbent at Different pH Values

The procedure described in Example 1 was repeated and the obtained 10% solution of iron oxide nanoadsorbent was used to purify a portion of polluted water: 1000 ml aqueous solution containing 40 ppm PO₄⁻³ with initial pH=6.4. After the addition of iron oxide nanoadsorbent, the pH level of the water was adjusted to various values by adding solution of NaOH. As a result, phosphate adsorption process onto nanoadsorbent was performed at different pH values of the solution. The adsorbent loaded with phosphate contaminants was removed from water as concentrated sludge by means of filtration using 0.45 μm filter paper.

The results of purification of polluted water experiments for different pH final values are presented in Table 2.

TABLE 2
Phosphate removal from water using iron oxide nanoadsorbent

Adsorption characteristics

| | | |
|---|---|---|
| | Concentration, ppm | |
| Experiment | Residual, end of process | pH |

| Number | PO₄⁻³ | Iron oxide nanoadsorbent | of process |
|---|---|---|---|
| 2-1 | 0.05 | 0.05 | 5.0 |
| 2-2 | 0.05 | 0.05 | 5.4 |
| 2-3 | 0.1 | 0.2 | 6.1 |
| 2-4 | 0.33 | 0.1 | 6.6 |
| 2-5 | 1.1 | 0.95 | 6.96 |
| 2-6 | 1.5 | 1.3 | 7.0 |
| 2-7 | 8.25 | 12.25 | 7.5 |

The initial iron oxide nanoadsorbent concentration was 75 ppm. The concentration of PO₄⁻³ was reduced in these experiments from 40 ppm to 0.05-0.1 ppm for pH values of 5-6 during the adsorption process (exp. 2-1 and 2-2), to 1.5 ppm at pH 7 (exp. 2-6) and to 8.25 ppm at pH values above 7.5 (exp. 2-7). Thus, the adjusted pH values demonstrated significant influence on adsorption activity of the iron oxide nanoadsorbent. In all these experiments no adsorption of the organic pollutant (phenol) onto iron oxide nanoadsorbent could be observed. The residual phenol concentration stayed unchanged in the original solution.

### Example 3

### Removal of Phosphate from Water Using Iron Oxide Nanoadsorbent and Recovery of the Adsorbent and of the Phosphate

The procedure described in Example 1 was repeated and the obtained 10% sol iron oxide nanoadsorbent was used to purify a portion of simulated polluted water: 1000 ml aqueous solution containing 40 ppm PO₄⁻³ and 50 ppm Ca⁺². The concentration of PO₄⁻³ was reduced in these experiments from 40 ppm PO₄⁻³ to 0.01-0.18 ppm at pH values of 4-5. The adsorbent loaded with phosphate contaminants was removed from the water solution as concentrated sludge by filtration using 0.45 μm filter paper.

Recovery at elevated pH removed the adsorbent and produced concentrated phosphate solution. The pH of the slurry was adjusted to pH values of 8-12.5 in order to release the adsorbent from adsorbed phosphates while producing concentrated phosphate solution. The concentrated slurry was filtered using 0.45 μm filter paper to yield iron oxide nanoadsorbent free of phosphate. The phosphate removal efficiency was calculated from the mass balance, as follows:

$$R = \frac{{m}_{1}}{{m}_{0}} 100 ( \% )$$

where: m₀-mass of phosphate in the initial solution (40 ppm PO₄⁻³), m₁-mass of phosphate in concentrated phosphate solution The concentration of the phosphate at the high pH concentrated solution in these experiments varied between 400-600 ppm, depending on the amount of solution used for the wash and may increase to higher levels.

The results of phosphate removal at different pH values are presented in Table 3.

TABLE 3
Phosphate Removal Efficiency

| Experiment number | pH | Phosphate removal efficiency, % |
|---|---|---|
| 3-1 | 10.0 | 35.6 |
| 3-2 | 10.5 | 74.2 |
| 3-3 | 11.0 | 92.7 |
| 3-4 | 11.5 | 96.1 |
| 3-5 | 12.0 | 100 |
| 3-6 | 12.5 | 99.8 |

It is clear that at pH>11, 93-100% phosphate removal was achieved concomitantly to the adsorbent recovery.

### Example 4

### Removal of Phosphate from Water Using Regenerated Iron Oxide Nanoadsorbent

The procedure for adsorbent recovery, phosphate removal and concentrated phosphate solution production described in Example 3 by adjusting pH values to pH=12 was repeated for additional 7 adsorption-recovery cycles. The phosphorous concentration was reduced in this 7^{th} cycle from 40 to 0.25 ppm and the phosphate removal efficiency was more than 99%. Thus, the recovered iron oxide nanoadsorbent after several adsorption-recovery cycles maintained the adsorption activity of fresh, previously unused virgin nanoadsorbent.

### Example 5

### Selective Removal of Phosphate from Water Using Iron Oxide Nanoadsorbent at Different pH Values

The procedure described in Example 1 was repeated for preparation of iron oxide nanoadsorbent. The 10% sol iron oxide nanoadsorbent was used to purify a portion of polluted water: 1000 ml aqueous solution containing 40 ppm PO₄⁻³ and 110 ppm phenol as TOC with initial pH=6.4. After addition of iron oxide nanoadsorbent: 40 ppm as Fe, the final pH values of the water was adjusted by adding solution of NaOH. The adsorbent loaded with phosphate contaminants was removed from water as concentrated sludge by filtration using 0.45 μm filter paper. The results of purification of polluted water at different pH values are presented in Table 5.

TABLE 4
Phosphate Removal from Water

| | Residual phosphate concentration, | |
|---|---|---|
| Experiment Number | ppm as PO₄⁻³ | Adjusted pH |
| 5-1 | 0.15 | 4.64 |
| 5-2 | 0.2 | 4.8 |
| 5-3 | 0.75 | 4.84 |
| 5-4 | 4.75 | 6.07 |
| 5-5 | 28.75 | 6.7 |
| 5-6 | 34.5 | 7.2 |
| 5-7 | 42.75 | 8.4 |

The concentration of PO₄⁻³ was reduced in these experiments from 40 ppm PO₄⁻³ to 0.15-0.2 for adjusted pH values of 4-5 (exp. 5-1 and 5-2), and to 34.5 ppm for adjusted pH values of above 7.2 (experiment 5-6). Thus, the adjusted pH values demonstrated significant influence on adsorption activity of the iron oxide nano-adsorbent. In all these experiments, no adsorption of the organic pollutant (phenol) onto the iron oxide nanoadsorbent was observed. The residual phenol concentration was unchanged. The mass of adsorbed PO₄⁻³ per unit mass of nanoadsorbent was in the range of 1000-1100 mg/g. Therefore, the iron oxide nanoadsorbent demonstrated extremely high selective phosphate adsorption activity.

### Example 6

### Stability (Aging Effect) of the Nano-Adsorbent

A series of experiments were conducted to investigate the adsorption properties of the iron oxide nano-adsorbent as a function of its aging. The experiments were carried out at room temperature. In all these experiments the initial concentration of phosphate was 40 ppm, and 50 ppm of Ca⁺² were present. The nano-adsorbent concentration was 40 ppm (as Fe). In these experiments the initial acidity (pH=2.5) of the contaminated water was chosen to avoid precipitation of calcium phosphate. After addition of the iron oxide based nano-adsorbent, the pH of the water was adjusted to 4.0-4.1 by adding a solution of NaOH. The adsorbent loaded with phosphate contaminants was removed from the water by filtration using 0.45 μm filter paper.

The residual phosphate concentration using fresh nano-adsorbent as well as for aged nano-adsorbent (10, 30 and 90 days) were about 0.05 ppm. Therefore, no adverse effect of aging on adsorption performance was detected. In addition, in all the experiments no effect of aging on the sorption kinetics for phosphate removal was found.

### Example 7

### Removal of Phosphate from Water: Comparing Activated Carbon and Activated Carbon Loaded with Iron Oxide Nano-Adsorbent

3.5 g activated carbon was mixed with 100 ml aqueous solution containing 40 ppm PO₄⁻³. The concentration of PO₄⁻³ was reduced in this experiment from 40 ppm to 12.5 ppm. No nano-particles were used.

The described procedure in Example 1 was repeated and the obtained 10% solution of iron oxide nano-adsorbent was used to prepare a portion of activated carbon loaded with iron oxide nano-adsorbent: to 100 ml of distilled water, 0.7 ml of the 10% iron oxide solution was added. The obtained solution was mixed with 10 g of loaded activated carbon. The loaded activated carbon was separated from the solution following the adsorption of iron oxide nanoparticles onto the activated carbon, by filtration using 0.45 μm filter paper. 2.5 g of the loaded activated carbon was mixed with 1.0 g of fresh activated carbon and added to 100 ml of aqueous solution containing 40 ppm PO₄⁻³. The concentration of PO₄⁻³ was reduced from 40 ppm PO₄⁻³ to 0.5 ppm. At the end of the process, the residual Fe concentration in the purified water was lower than 0.2 ppm. Thus, activated carbon loaded with iron oxide nanoparticles demonstrated high adsorption activity versus the unloaded activated carbon.

### REFERENCES

Andreozzi, R., Caprio, V., Insola, A., Marotta, R., 1999, Advanced oxidation process for water purification and recovery. Catalysis Today. 53, 51-59.
Burdick, C, R., Refling, D., R., Stensel, H., D., 1982. Advanced biological treatment to achieve nutrient removal. J. Water Pollut. Contr. Fed. 54, 1078-1086.
De Laat, J., Le, G. T., Legube, B., 2004. A comparative study of the effects of chloride, sulfate and nitrate ions on the rates of decomposition of H₂O₂ and organic compounds by Fe⁽⁺²⁾/H₂O₂ and Fe⁽⁺³⁾/H₂O₂. Chemosphere. 55, 715-723.
Donnert, D., Salecker, M., 1999a. Elimination of phosphorus from waste water by crystallization. Environ. Technol. 20, 735-742.
Donnert, D., Salecker, M., 1999b. Elimination of phosphorus from municipal and industrial waste water. Water Sci. Technol. 40, 195-202.
Ivanov, V., Zhuang, W., Q., Tay, J., H., Tay, S., T., L., Stabnikov, V., 2005. Phosphate removal from the returned liquor of municipal wastewater treatment plant using iron-reducing bacteria, J. Appl. Microbiol. 98, 1152-1161.
Jenkins, D., and Hermanowich, S., W., 1991. Principles of chemical phosphate removal. In phosphorous and nitrogen removal from municipal wastewater: principles and practice (ed. Sedlak R., I.) 2^{nd} edn., pp. 91-108. Lewis Publishers, New York, N.Y.
Lu, M. C., Chen, J. N., Chang, C. P., 1997. Effect of inorganic ions on the oxidation of dichlorvos insecticide with Fenton's reagent. Chemosphere. 35(10), 2285-2293.
Ma, J., Zhu, L., 2006. Simultaneous sorption of phosphate and phenanthrene to inorgano-organo-bentonite from water. Journal of Hazardous Materials, B136, 982-988.
Moriyama, K., Kojima, T., Minawa, Y., Matsumoto, S., Nakamachi, K., 2001. Development of artificial seed crystal for crystallization of calcium phosphate. Environ. Technol. 22, 1245-1252.
Neyens, E., Baeyens, J., 2003. A reviews of classic Fenton's peroxidation as an advanced oxidation technique. Journal of Hazardous Materials. B98, 33-50.
Oguz, E., 2004. Removal of phosphate from aqueous solution with blast furnace slag, J. Hazard. Mater. 114, 131-137.
Oliveros, E., Legrini, O., Holb, M., Muller, T., Braun, A., 1997. Industrial wastewater treatment: large scale development of a light-enhanced Fenton reaction. Chemical Engineering and Processing. 36, 397-405
Perez, M., Torrades, F., Garcia-Hortal, J A, Domenech, X., Peral, J., 2002. Removal of organic contaminants in paper pulp treatment effluents under Fenton and photo-Fenton conditions. Applied Catalysis. 36, 63-74.
Randall, C. W.; Rowell, E. H.; King, P. H., 1971. Adsorption and removal of phosphate by flyash and coal contact systems. Proceedings of the Southern Water Resources and Pollution Control Conference. 20, 208-27.
Rhoton, F., E., Bigham, J., M., 2005. Phosphate adsorption by ferrihydrite amended soils, J. Environ. Qual. 34. 890-896.
Roostaei N., and Tezel F., H. (2004) removal of phenol from aqueous solutions by adsorption. J. Environ. Management, 70, 157-164.
Safarzadeh-Amiri, A., Bolton, J. R., and Cater, S. R., 1997. Ferrioxalate-mediated photo degradation of organic pollutants in contaminated water. Wat. Res. 31, 787-798.
Safarzadeh-Amiri, A., Bolton, J. R., Cater, S. R., 1996. The use of iron in advanced oxidation processes. J. Adv. Oxid. Technol. 1 (1), 18-26.
Sigman, M. E., Buchanan, A. C., Smith S. M. (1997) Application of advanced oxidation process technologies to extremely high TOC aqueous solutions. J. Adv. Oxid. Technol. 2, 415-423.
Stensel, H., D., 1991. Principles of biological phosphorus removal. In phosphorous and nitrogen removal from municipal wastewater: principles and practice (edited by Sedlak R., I.) 2^{nd} edn., pp. 141-163. Lewis Publishers, New York, N.Y.
Tanada, S., Kawasaki, N., Nakamura, T., Araki, M., Kabayama, M., Sakiyama, T., Tamura, T., 2003. Removal of phosphate by aluminum oxide hydroxide. J. Colloid Interface Sci. 257. 135-140.].
Toledo, L S, Bernardes Silva, A C, Augusti, R., Lago, R M, 2003. Application of Fenton's reagent to regenerate activated carbon saturated with organochloro compounds. Chemosphere. 50, 1049-1054.
Van den Heuvel, H., Van Noort, P C, M., 2004. Removal of indigenous compounds to determine maximum capacities for adsorption of phenanthrene by sediments, Chemosphere 54, 763-769.
Yeber, M C, Rodriguez, J., Freer, J., Duran, N., Mansilla, H D, 2000. Photo catalytic degradation of cellulose bleaching effluent by supported TiO₂ and ZnO. Chemosphere. 41, 1193-1197.
Yi, W G, Lo, K V, 2003. Phosphate recovery from greenhouse wastewater. J. Environ. Sci. Heal. B 38, 501-509.
Zhao, D., and Sengupta, A K, 1998. Ultimate removal of phosphate from wastewater using a new class of polymeric ion exchangers. Wat. Res., 32, 5. Pp. 1613-1625.

1. A method for treating a polluted aqueous fluid containing undesired phosphate contaminants, comprising selective adsorption of said phosphate contaminants onto particles of an adsorbent material selected from: (i) particles of oxides or hydroxides of transition metals, aluminum oxides or hydroxides, TiO₂, or mixtures thereof, or (ii) particles of activated carbon, activated alumina, aluminum oxide, activated TiO₂, TiO₂, mineral clay, zeolite, or an ion exchanger loaded with nano-particles of oxides or hydroxides of transition metals, aluminum oxides or hydroxides or TiO₂, or mixtures thereof, by mixing with or passing the polluted aqueous fluid through said adsorbent material to yield aqueous fluid purified from phosphate.

2. The method according to claim 1, wherein the treated aqueous fluid is water.

3. The method according to claim 2, wherein the aqueous fluid is potable water, tap water, ground water, or industrial, agricultural or municipal wastewater.

4. The method according to claim 1, wherein the aqueous fluid is obtained from sludge or other solid waste mixed with or adsorbed by soil contaminated with phosphate, wherein the sludge, soil waste or soil is extracted with acidulated water to produce an aqueous fluid containing the undesired phosphate contaminants.

5. The method according to any of claims 1 to 4, wherein said adsorbent material is an oxide or hydroxide of transition metal selected from iron (2,3) oxides or hydroxides, aluminum oxides or hydroxides, TiO₂, or mixtures thereof.

6. The method according to claim 5, wherein said iron (2,3) oxide or hydroxide is selected from Fe₂O₃, FeOOH, FeFe₂O₃, Fe(OH)₃, MnFe₂O₃; CoFe₂O₃, CuFe₂O₃, FeO, or a mixture thereof.

7. The method according to claim 6, wherein said iron (2,3) oxide is an iron (3) oxide.

8. The method according to claim 5, wherein said aluminum oxide or hydroxide is selected from Al₂O₃, AlOOH, Al(OH)₃, or a mixture thereof.

9. The method according to claim 1, wherein the particles of the adsorbent material are in form of nano-particles or colloids.

10. The method according to claim 1, wherein the adsorbent material is virgin.

11. The method according to claim 1, wherein the adsorbent material is regenerated.

12. The method according to claim 1, wherein the adsorption of the phosphate contaminants onto the particles of the adsorbent material is carried out at pH from about 2 to about 7, preferably from pH 4 to 6.5.

13. The method according to claim 1, further comprising regeneration of the adsorbent material and of the phosphate for further use, comprising the following steps:
(i) separating the adsorbent material loaded with the undesired phosphate contaminants from the purged water by filtration, thus producing a concentrated sludge;
(ii) treating the produced concentrated sludge by increasing the pH;
(iii) recovering the adsorbent material free from phosphate contaminants and producing a concentrated phosphate solution or a phosphate crystal slurry; and
(iv) separating the regenerated purified adsorbent from the phosphate solution or slurry.

14. The method according to claim 13, wherein in step (ii) the pH is adjusted to pH values from about 7.5 to about 13, preferably from 8 to 12.5.

15. The method according to claim 13, wherein the recovery step (iii) is carried out by adding salts or hydroxides of Na, Ca, K, Mg, NH₄, or mixtures thereof.

16. The method according to claim 1, further comprising removal of organic and biological pollutants from the treated aqueous fluid.

17. The method according to claim 16, wherein the removal of the organic and biological pollutants is carried out by techniques including Advanced Oxidation Processes (AOPs), biological wastewater treatment or by a sorption process.

18. A method for treating a polluted aqueous fluid containing undesired phosphate contaminants and organic and/or biological contaminants, comprising selective adsorption of said phosphate contaminants onto particles of an adsorbent material and concomitant recovery of the purified adsorbent material and of the purified phosphate for further use, said method comprising:
(i) adsorbing the phosphate contaminants onto particles of oxides or hydroxides of transition metals, aluminum oxides or hydroxides, TiO₂, or mixtures thereof, or particles of activated carbon, activated alumina, aluminum oxide, activated TiO₂, TiO₂, mineral clay, zeolite, or an ion exchanger loaded with nano-particles of oxides or hydroxides of transition metals, aluminum oxides or hydroxides or TiO₂, or mixtures thereof, by mixing or passing the polluted aqueous fluid through said adsorbent material;
(ii) separating the adsorbent material loaded with the undesired phosphate contaminants from the purged water by filtration, thus producing a concentrated sludge;
(iii) treating the produced concentrated sludge by increasing the pH;
(iv) recovering the adsorbent material free from phosphate contaminants and producing a concentrated phosphate solution or a phosphate crystal slurry free from organic contaminants;
(v) separating the regenerated purified adsorbent free from phosphate contaminants from the phosphate solution or slurry, thus obtaining purified adsorbent material and purified phosphate solution or phosphate crystals slurry for further use; and
(vi) removing remained organic and biological pollutants in the treated aqueous fluid by Advanced Oxidation Processes (AOPs), biological wastewater treatment or by a sorption process, thus obtaining purified water free from phosphate, organic and biological pollutants.
